(19) United States
(12) Patent Application Publication
(10) Pub. No.: US 2009/0258129 A1
(43) Pub. Date: Oct. 15, 2009

(54) VOLUMIZED, DEBITTERED, HIGH-INTENSITY SWEETENER COMPOSITION

(76) Inventor: Warren Sablosky, Eugene, OR (US)

Correspondence Address: KOLISCH HARTWELL, P.C., 200 PACIFIC BUILDING, 520 SW YAMHILL STREET, PORTLAND, OR, 97204, US

(21) Appl. No.: 12/404,194

(22) Filed: Mar. 13, 2009

Related U.S. Application Data
(60) Provisional application No. 61/036,835, filed on Mar. 14, 2008.

(51) Int. Cl. A23L 1/236

(52) U.S. Cl. 426/548

(57) ABSTRACT

A sweetener composition includes a high-intensity sweetener, a filler, and a debittering agent. The sweetener composition is adapted for use as a 1:1 cooking or baking substitute, by weight or volume, for table sugar.

### CROSS-REFERENCE TO RELATED APPLICATIONS

This application claims priority to U.S. Provisional Patent Application Ser. No. 61/036,835, filed Mar. 14, 2008 and entitled “Volumized, Debittered, High-Intensity Sweetener Composition”, the disclosure of which is hereby incorporated by reference.

### BACKGROUND

The present application relates to blends of edible substances that can be used to sweeten other food products or blends of other food products.

### DESCRIPTION OF THE INVENTION

The present invention performs the function of replacing sugar on a 1/1 basis (whether by weight or volume) in food recipes. The invention also performs the functions of reducing calories associated with the food products made from the food recipes. The invention also performs the function of promoting health because it contains a fiber component which provides various health-promotion effects, including improved circulation, thereby improving the health of the heart.

Generally, the invention includes the following two components: (1) a high-intensity sweetener; and (2) a filler. As to the first component, the high-intensity sweetener may include one or more of the following materials: stevia, derivatives of stevia such as rebaudioside-A, stevia glycosides, and steviosides, sucralose, aspartame (such as the commercial product sold under the trademark NutraSweet®), acesulfame K (such as the commercial product sold under the trademark Sunette®), saccharin (such as the commercial product sold under the trademark Sweet n' Low®), thaumatin, brazzein, and glycyrrhizin, cyclamates, Neotame, neohesperidin, dihydrochalone, alitame.

The second component may include substances from the following group, which perform the functions of volumizing, thickening, sweetening, binding and browning: dextrin, maltodextrin, guar gum, xantham, fibers, tapioca, acacia gum (also known as gum acacia and gum arabic), and xantham gum.

The invention may also include a de-bitterizing agent or bitter-masking agent.

A representative formulation of the invention is shown below:

| Component | % by weight |
|---|---|
| Maltodextrin | 46.3 ± 5 |
| Dextrin | 32.8 ± 5 |
| Oat fibers | 13.66 ± 5 |
| Acacia gum | 2.73 ± 0.3 |
| Tapioca | 1.36 ± 0.3 |
| Guar gum | 1.36 ± 0.3 |
| Stevia | 0.97 ± 0.1 |
| Xantham | 0.82 ± 0.1 |
| Total | 100 |

If a bitter-masking agent were to be used in the above formulation, it would be added as 0.003% by weight, and there would be 0.003% by weight less of either maltodextrin, dextrin or oat fibers.

The invention may also be thought of as comprising prebiotic fibers and sweeteners, and possibly other non selective fibers, minerals, vitamins and probiotic strains.

The invention may also be thought of as a baking compound that, when used in food recipes, causes the following to the food product made with the baking compound according to the recipe: (1) increases both soluble and insoluble fiber; (2) has pro-biotic effects; (3) cuts calorie content; and (4) lowers carbohydrate value. That baking compound also acts as a one-to-one sugar substitute either as a dietary supplement to reduce sugar in food recipes, or as a sugar substitute. The baking compound also reduces the percentage of fat in a food recipe, while also improving certain other aspects of the food product containing it, i.e. increasing shelf life, and improving texture and taste.

The disclosure set forth above encompasses multiple distinct inventions with independent utility. While each of these inventions has been disclosed in a preferred form or method, the specific alternatives, embodiments, and/or methods thereof as disclosed herein are not to be considered in a limiting sense, as numerous variations are possible. The present disclosure includes all novel and non-obvious combinations and subcombinations of the various elements, features, functions, properties, methods and/or steps disclosed herein. Similarly, where any disclosure above recites “a” or “a first” element, step of a method, or the equivalent thereof, such disclosure should be understood to include one or more such elements or steps, neither requiring nor excluding two or more such elements or steps.

Inventions embodied in various combinations and subcombinations of features, functions, elements, properties, steps and/or methods may be claimed through presentation of claims in a related application. Such claims, whether they are directed to a different invention or directed to the same invention, whether different, broader, narrower, or equal in scope to the original claims, are also regarded as included within the subject matter of the present disclosure.

I claim:

1. A sweetener composition comprising:
a high-intensity sweetener;
a filler; and
a debittering agent;
wherein the sweetener composition is adapted for use as a 1:1 weight:weight or a 1:1 volume:volume cooking or baking substitute for table sugar.

2. The sweetener composition of claim 1 having a sweetness that is substantially similar to table sugar.

3. The sweetener composition of claim 1, wherein the high-intensity sweetener comprises one or more compounds selected from the group consisting of stevia, derivatives of stevia such as rebaudioside-A, stevia glycosides, and steviosides, sucralose, aspartame, acesulfame K, saccharin, thaumatin, brazzein, and glycyrrhizin, cyclamates, Neotame, neohesperidin, dihydrochalone, alitame.

4. The sweetener composition of claim 1, wherein the high-intensity sweetener is a stevioside.

5. The sweetener composition of claim 1, wherein the filler comprises one or more components selected from the group consisting of dextrin, maltodextrin, guar gum, xantham, fibers, tapioca, acacia gum, and xantham gum.

6. The sweetener composition of claim 1, wherein the filler comprises 46.3 +/− 0.5% by weight maltodextrin and 32.8 +/− 0.5% by weight dextrin.
